(19) United States
(12) Patent Application Publication
(10) Pub. No.: US 2022/0387145 A1
(43) Pub. Date: Dec. 8, 2022

(54) SYSTEM ASSEMBLY INTERFACE

(71) Applicant: Bruno SPINDLER, Oppenau (DE)

(72) Inventors: Bruno SPINDLER, Oppenau (DE); Timo REUTER, Bruchsal (DE)

(73) Assignee: Bruno SPINDLER, Oppenau (DE)

(21) Appl. No.: 17/773,708

(22) PCT Filed: Nov. 2, 2020
(86) PCT No.: PCT/DE2020/000264

§ 371 Date: Jun. 27, 2022

(30) Foreign Application Priority Data
Nov. 4, 2019 (DE) 102019007624.9

(51) Int. Cl. A61C 8/00

(52) U.S. Cl. CPC A61C 8/0068; A61C 8/0074; A61C 8/0069

(57) ABSTRACT

A system assembly interface between a multi-part superstructure carrier, which carries a superstructure, and an implant body, which has an internal thread, is disclosed. A part of the superstructure carrier is arranged on the implant body via an implant screw bolt. The superstructure carrier comprises a superstructure main carrier and an attachment carrier that is detachably screwed to it. The system assembly interface ensures secure support of the superstructure with simple pre-assembly and final assembly. In the case of a plurality of implant bodies carrying a partial or total prosthesis, no appreciable stresses occur despite static overdetermination.

### TECHNICAL FIELD

The disclosure relates to a system assembly interface between a multi-part superstructure carrier, which carries a superstructure, and an implant body, which has an internal thread, wherein a part of the superstructure carrier is arranged on the implant body via an implant screw bolt.

### BACKGROUND

In dental implantology, among other things, an endosseous implant body is often used to support the prosthesis as part of the fabrication of a single-tooth denture. In this case, the implant body, a type of screw dowel, is screwed into an artificially created bore in the patient's jaw. The screwed-in implant body accommodates an implant post in the finished prosthesis. The latter is secured against rotation in the implant body with a special tightening device. A superstructure forming the visible tooth crown is placed directly or indirectly on the implant post, for example by means of bonding. If a bridge, partial or full denture is required instead of the dental crown, the latter is formed by a plurality of combinations of implant bodies and superstructure carriers.

From WO 2012/039 819 A1, a dental implant abutment system is known with which a superstructure carrier without an implant post is attached to an implant body by means of an abutment screw. In order to be able to attach a prosthesis-bearing implant post to the superstructure body by means of a screw connection, an implant plate with a central internal thread is formed on the superstructure carrier, which is inclined towards the center line of the implant body. Thus, the superstructure body has two different bores that end in three openings of the superstructure carrier.

### SUMMARY

The present disclosure provides an improved system assembly interface between a superstructure carrier and an implant body in such a manner that, on the one hand, a secure carrying of the superstructure is ensured with simple pre-assembly and final assembly and, on the other hand, no measurable stresses occur in the case of a plurality of implant bodies supporting a partial or total prosthesis despite static overdetermination.

This is achieved by the features as claimed. The superstructure carrier consists of a superstructure main carrier and an attachment carrier that is detachably screwed to it. The superstructure main carrier has a recess open towards the attachment carrier and towards the implant body. An internal thread is arranged in the recess in its region turned towards the implant body. The implant screw bolt has two external threads arranged one behind the other with or without a spacing, the first of which is an external drive thread and the second of which is an external tightening thread. Both external threads have different slopes. The external drive thread fits into the internal drive thread of the recess of the superstructure main carrier and the external tightening thread fits into the internal tightening thread of the implant body. The attachment carrier has a recess open towards the superstructure and the superstructure main carrier. An internal thread or screw head seating surface is arranged in the recess in its region turned towards the superstructure main carrier.

The disclosure provides a system assembly interface that connects an implant body to a superstructure via a superstructure main carrier and an attachment carrier. In the process, the superstructure main carrier and the attachment carrier between the implant body and the superstructure can, on the one hand, be mutually pivoted in the assembly joints. On the other hand, there is a large number of superstructure main carriers and attachment carriers that differ from each other only in that they have different angular deflections. In this manner, the implant body, the superstructure main carrier and the attachment carrier form a carrier—usually not straight—with two assembly joints, which is connected to each other via screw bolts and/or screws. All three substantially tubular components are closed all around except for an opening at the end, in the internal thread of which the superstructure is held by means of a screw bolt or screw, such that virtually no notch effects negatively affecting component strength occur along the newly created carrier.

Of course, in the first assembly joint, the screw bolt can be replaced by a screw provided with a screw head.

### BRIEF DESCRIPTION OF THE DRAWINGS

FIG. 1: Longitudinal section through a system assembly interface of an implant-supported total prosthesis;

FIG. 2: Longitudinal section through a prosthetic denture in the form of a partial prosthesis;

FIG. 3: Longitudinal section through a system assembly Interface with multiple bends;

FIG. 4: Perspective view of FIG. 3;

FIG. 5: Perspective view of a long implant screw bolt;

FIG. 6: Perspective view of an attachment carrier screw;

FIG. 7: Perspective view of a short implant screw bolt;

FIG. 8: Perspective view of an attachment carrier screw bolt;

FIG. 9: Perspective view of a superstructure main carrier with a conical post;

FIG. 10: Perspective view of a straight superstructure main carrier with a spherical post;

FIG. 11: As in FIG. 10, but with an angled recess to accommodate an attachment carrier fastening means;

FIG. 12: As in FIG. 11, but with greater angular deflection;

FIG. 13: Perspective view of a straight attachment carrier with a support plate;

FIG. 14: As in FIG. 13, but with an angled attachment carrier post;

FIG. 15: As in FIG. 14, but with a more angled attachment carrier post;

FIG. 16: Longitudinal section to FIG. 15;

FIG. 17: Perspective view of a straight attachment carrier without a support plate;

FIG. 18: As in FIG. 17, but as an angled attachment carrier;

FIG. 19: As in FIG. 18, but with greater angular deflection;

FIG. 20: Perspective view of a straight tracing pin with an anti-rotation lock.

### DETAILED DESCRIPTION

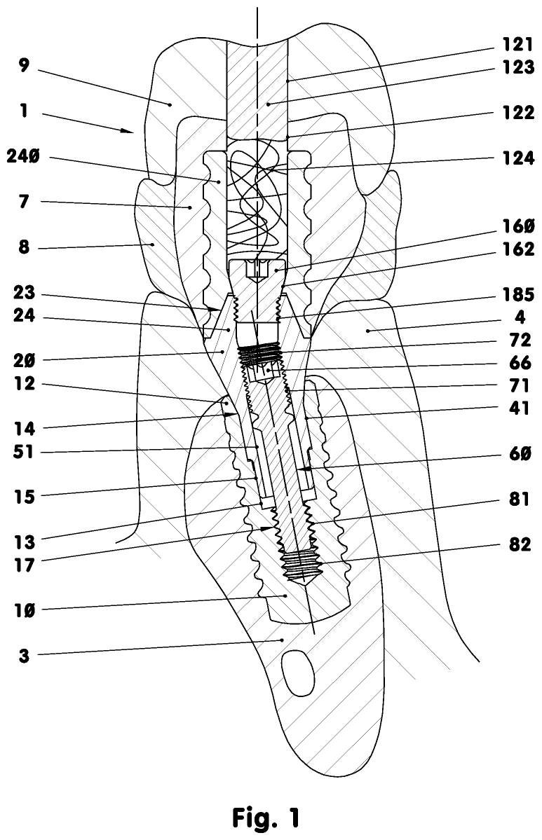

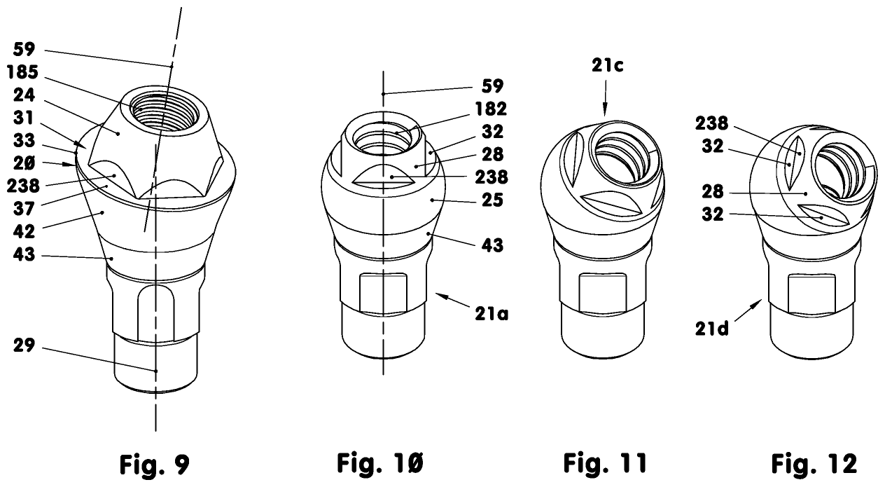

FIG. 1 shows a prosthetic denture (1) in the form of a total prosthesis. The latter is built up on several implant bodies (10) screwed into the jawbone (3). The jawbone section shown is located—viewed from the patient—in the region of the molar teeth on the right side of the jaw. The section is oriented perpendicular to the masticatory plane, for example. A superstructure main carrier (20), for example, an angled one, is seated in the implant body (10) in a conical seat (14), see also FIG. 9. The superstructure main carrier (20) is held in the conical seat (14) by means of a special screw bolt (60). An attachment carrier (240) is seated on the single superstructure main carrier (20) and screwed in place by means of an attachment carrier screw (160). The attachment carrier (240) is part of a rigid metal or plastic reinforcement (7). The crowns (9) made of ceramic, for example, are anchored in the reinforcement (7). Between the gum (4) and the crown (9), an elastic plastic material surrounds the reinforcement (7) as a replica of the artificial gum (8) surrounding the crowns (9).

For cleaning and maintenance purposes, the total prosthesis is detached from the superstructure main carrier (20) in a cycle, for example every six months. To make this possible, the attachment carrier screws (160) can be accessed with little effort. For this purpose, the crowns (9) arranged above the implant bodies (10) are each provided with a bore (121) in the denture (1), which is followed by a bore (122), for example in the reinforcement (7) according to FIG. 1. The bore (121) and part of the bore (122) are sealed with a sealing plug (123) made of a plastic material cured under UV light. A Teflon tape (124) is caulked between the sealing plug (123) and the attachment carrier screw (160) in the central bore (244) of the attachment carrier (240) as filler material.

After the sealing plug (123) has been drilled out without difficulty, the Teflon tape (124) can be pulled out so that the attachment carrier screw (160) can thereafter be loosened.

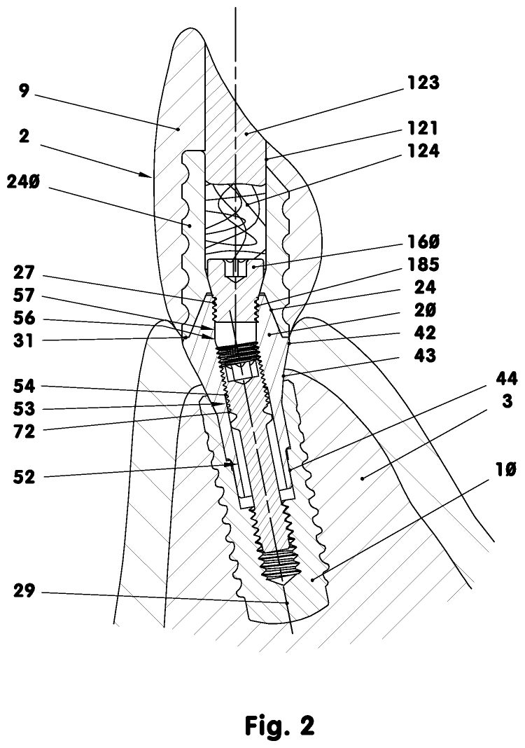

FIG. 2 shows a prosthetic denture, for example a bridge (2) consisting of two to four incisors. The illustrated longitudinal cross section of the lower jaw passes through one of the anterior incisors, which is supported in the jawbone (3) by means of the implant body (10). Here, the crown (9) is mounted directly on the short attachment carrier (240). The closing of the bores (121, 122) takes place as described above.

The base of the prosthetic denture (1) is an implant body (10) that can be screwed into the jawbone. It is a hollow screw with a possibly self-tapping, for example non-metric external thread. Approximately in the upper half, the implant body (10) has the multi-level recess (13), which is divided into three zones, see FIGS. 1, 2 and 3. The first zone (14)—located in the region of the implant shoulder (12) of the implant body (10)—is an internal cone, which has a taper angle of, for example, 18 angular degrees. The internal cone (14) merges into an internal hexagon (15) of the second zone, which serves as an anti-rotation lock (44). Instead of the internal hexagon (15), a double internal hexagon or another positively locking or force-fitting anti-rotation geometry can also be used as the coupling geometry, for example. The first and second zones (14, 15) form the first assembly joint (41).

The third zone (17) is a threaded bore with a internal tightening thread (82) that receives the screw bolt (60) holding the superstructure main carrier (20) during assembly. The clockwise-ascending internal tightening thread (82) is, for example, an M 1.6×0.35 thread according to DIN 13, sheet 1.

The primary function of the superstructure main carrier (20)—seated in the implant body (10)—is to serve as the first base for the artificial tooth crown (1, 2). It has a region turned towards the implant body (10) and a region turned towards the attachment carrier (240).

The region turned towards the implant body (10) is the implant neck (42) with its external cone (43) and external hexagon (44). The external cone (43) and the external hexagon (44) fit precisely in the recess (13) of the implant body (10). In the axial direction facing the tip of the implant body (10), the end faces of the external hexagon (44) do not contact the recess (13).

Above the implant neck (42), an implant plate (31) is connected, which may emerge from the implant neck (42) with a continuous transition. The implant plate (31) has, at least in regions or sections, the shape of a plane or the shape of a truncated cone shell, the cone angle of which opens towards the tooth crown (9). For example, the underside of the implant plate (31) also consists of a plurality of diverging tapering cones, wherein each encloses a different angle with respect to the center line (29). The external rim (33) of the implant plate (31) has a distance to the center line (29) here, which amounts to, for example, 4.5 mm with a 360° rotation around the center line (29).

A cone-shaped implant post (23) rises above the implant plate (31), which has a flat rim upper side (37). The flat rim upper side (37) may form a seating surface for the attachment carrier (240). In accordance with FIGS. 1 and 2, the implant post (23) is a tapered post (24) that has an anti-rotation lock (238) in the form of an external hexagon. The surfaces of the external hexagon are either oriented parallel to the center line (59), or they are partial surfaces of a straight pyramid provided with six edges. The tapered post (24) and the anti-rotation lock (238) form a centering second assembly joint (239).

If applicable, the superstructure main carrier (20) is equipped with a titanium nitride coating at least above the implant plate (31). Its layer thickness amounts to, for example, 1 to 4 μm. Alternatively, thin-walled ceramic or copolymer coatings can be applied there.

According to FIGS. 1 and 2, the superstructure main carrier (20) has a through recess (51) that has a bend in the upper region with a bend angle of, for example, 11 angular degrees. The finished recess (51) consists of four zones. The first zone (52) and the second zone (53) serve the purpose of inserting the screw bolt (60). The first, lower zone (52) is a cylindrical bore. Its center line (49) coincides with the center line (29). It is followed by a second zone (53), for example, a right-hand internal thread (72), which is designated M 1.8×0.2 according to DIN 13, Sheet 2. The transition between the internal thread (72) and the bore (52) is formed by a flat stop collar (54).

The fourth, upper zone (57) is also a cylindrical bore with an internal thread (27). Its center line (59) intersects the center line (29) in the third zone (56), for example at an angle of 11 angular degrees. The upper zone (57) serves, on the one hand, for the introduction of the tool with which the screw bolt (60) is tightened. On the other hand, it is also the seat of the attachment carrier screw (160). The third zone (56) represents a rounded transition region having, for example, regions of the lateral surface of a hemisphere.

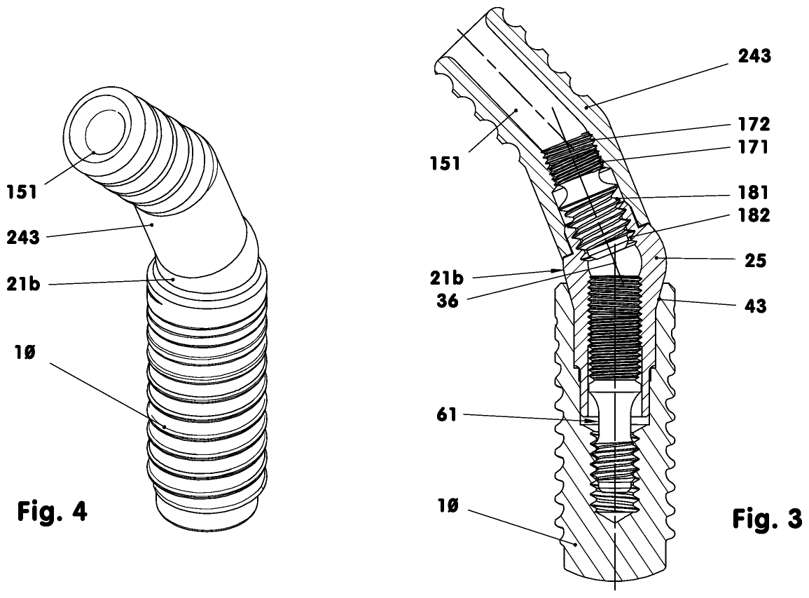

The system according to FIGS. 3 and 4 uses a superstructure main carrier (21b) that terminates in a spherical post (25) on the attachment carrier side. The implant cone (43) merges tangentially—without a crack, edge or implant plate—into the spherical shape of the spherical post (25). The center line (59) encloses an angle of 158 angular degrees with the center line (29) at the intersection (36). Thus, the bend angle or the angular deflection, as the case may be, of the center line (59) relative to the center line (29) amounts to 11 angular degrees. The intersection point (36) is also the center point of the spherical shape of the spherical post (25). This applies to both the external wall and the wall of its central recess.

FIGS. 10-12 show three more superstructure main carriers (21a, 21c, 21d) of this series.

FIG. 10 shows a straight superstructure main carrier (21a), with which the center line of the spherical post (25) coincides with the center line of the structure main carrier (21a). The spherical post (25) ends, as shown in FIG. 3, towards the attachment carrier (243) in a conical seat (28) in which four notches are machined. The shell lines of the shell of the conical seat (28), which intersect at a point on the center line (59), are tangent to the spherical surface of the spherical post (25).

The notches have four flanks, the surface normals of which are oriented parallel to the center line (59), on the one hand, and lie in one plane, on the other hand. As plate segments (32), these four flanks form an implant plate integrated into the shell geometry of the conical seat (28). They are comparable in total to the rim upper side (37) of the superstructure main carrier (20). The four other flanks of the notches lie in planes aligned parallel to the center line (59) and are part of the side surfaces of an imaginary cube. These flanks, which are equidistant from the center line (59), form the anti-rotation lock (238).

The superstructure main carrier (21c) shown in FIG. 11 has a 30° angular deflection, while the superstructure main carrier (21d) of FIG. 12 shows a 45° angular deflection. Of course, there is also a superstructure main carrier of this series with an 11° angular deflection. The angular deflection of the individual superstructure main carriers can also be carried out in three-angle or five-angle degree increments.

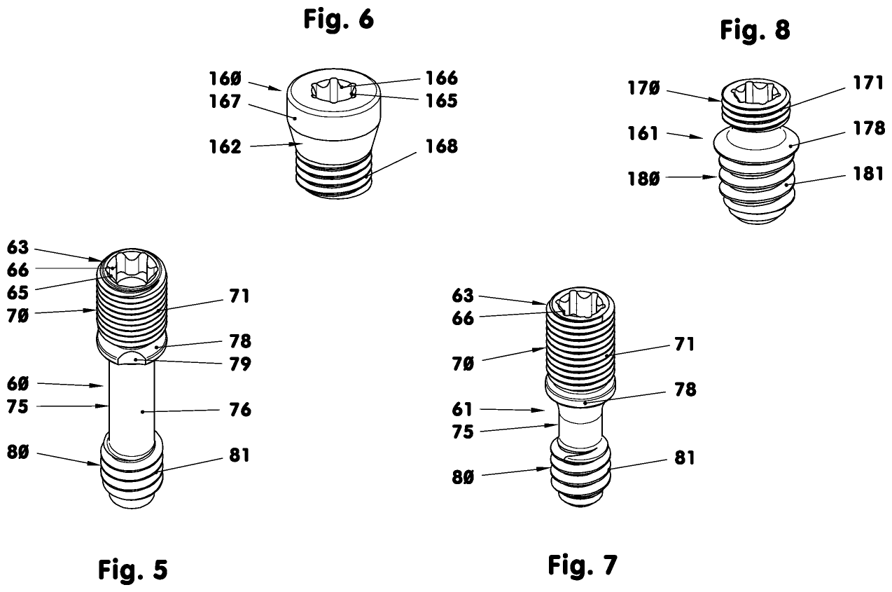

As a rule, the single screw bolt (60, 61) is divided into four regions. These are, lined up from front to back, an articulation region (63), a drive region (70), an intermediate region (75) and a tightening region (80), see FIGS. 5 and 7.

A tool recess (65) is machined into the articulation region (63). According to FIGS. 5 and 7, it is, for example, an internal hexagon socket (66) with a wrench size of, for example, 1.28 mm. Instead of the internal hexagon socket, an internal hexagon, an internal polyhedron, a cross slot, a slot or the like can also be provided. Another drive variant is an external hexagon socket or external hexagon. If applicable, the hexagonal round or hexagonal shapes are barrel-shaped in the axial direction.

According to FIGS. 5 and 7, the drive region (70) has a fine thread of the M 1.8×0.2 type. Fine threads other than drive threads (71, 72), such as M 2×0.25, M 1.8×0.2, M 1.6×0.25 or M 1.6×0.2, are also conceivable.

The intermediate region (75) adjoining the drive region (70) serves as a spacer to the subsequent tightening region (80). The intermediate region (75), according to FIG. 5, is composed of a cylinder journal (76) and a stop flange (78). If applicable, the outside diameter of the cylinder journal (76) corresponds to the core diameter of the external drive thread (71).

Towards the tightening region (80), a disk-shaped stop flange (78) adjoins the cylinder journal (76). The stop flange (78) has a wall thickness of, for example, 0.2 mm with an external diameter of, for example, 1.8 mm. The stop flange (78) has a notch (79) parallel to the screw center line that allows the venting of the threaded bore of the implant body (10).

The tightening region (80) represents a external tightening thread (81). Here, for example, it is a 1.46 mm long M 1.6×0.35 standard thread according to DIN 13, sheet 1.

FIG. 1 shows the superstructure main carrier (20) after the insertion of the screw bolt (60). For assembly, the screw bolt (60) is screwed with its external drive thread (71) into the region of the internal drive thread (72) until the stop flange (78) of the screw bolt (60) rests against the stop collar (54), see FIGS. 1, 2 and 3. The screw bolt (60) is now seated in a loss-proof manner in its rear position in the superstructure main carrier (20). In this form, the combination of the superstructure main carrier (20) and the screw bolt (60) can be sold.

After the insertion of the superstructure main carrier (20) into the stepped recess (13), the external tightening thread (81) is screwed into the internal tightening thread (82) of the implant body (10) by turning the screw bolt (60) clockwise. This pulls the superstructure main carrier (20) into the implant body (10). The screw-in procedure is completed as soon as the implant cone (43) is firmly seated in the internal cone (14) of the implant body (10). All four threads of the external tightening thread (81) are seated in the internal tightening thread (82). Similarly, the majority of the threads of the external drive thread (71) are located in the internal drive thread (72).

The screw bolt (61) of FIG. 7 serves the purpose of fastening the superstructure main carrier (21a, 21b, 21c, 21d) in the implant body (10), see FIGS. 3 and 4. It is largely comparable with the screw bolt (60). Substantially, the intermediate region (75) is formed to be shorter.

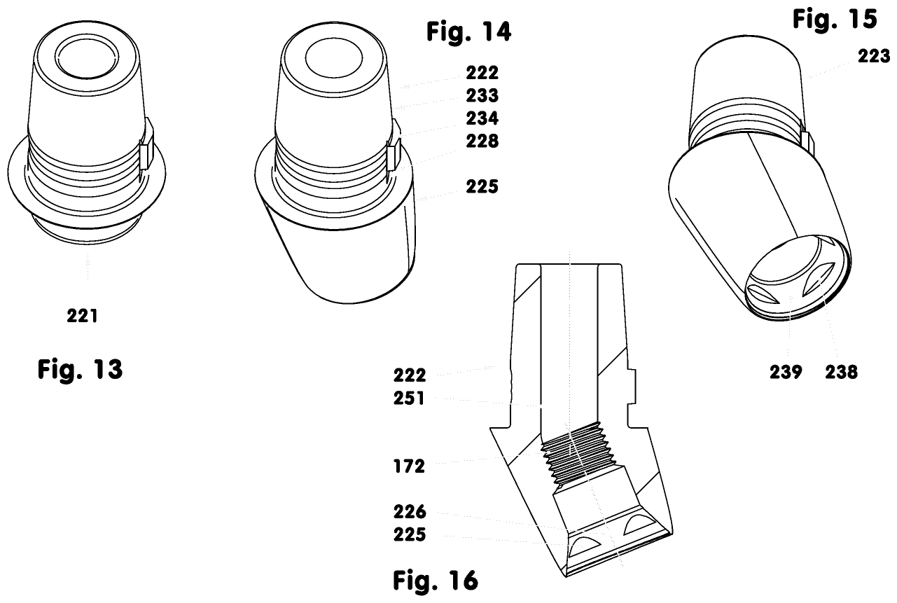

FIGS. 13-16 show an attachment carrier assembly consisting of three attachment carriers (221-223). Each of these attachment carriers (221-223) has a base section (225), an attachment carrier plate (228) for supporting a superstructure (1, 2) and an attachment carrier post (233).

All attachment carriers (221-223) of this group are suitable to be arranged on the superstructure main carriers (21a-21d). Between the respective superstructure main carrier and the attachment carrier placed on top of it, there is an attachment screw bolt (161) with opposing threads.

The attachment screw bolt (161) is shown in FIG. 8. It is similar in design to the screw bolts (60) and (61). Between a drive region (170) and a tightening region (180), there is a stop flange (178), the diameter of which is larger than the maximum thread diameter of the tightening region (180). The external drive thread (171) corresponds to an M 1.6×0.2 thread according to DIN 13. The external tightening thread (181), which is larger in diameter, is an M 1.8 standard thread. The tool recess machined into the drive region (170) is, for example, an internal hexagon socket.

All threads shown in the exemplary embodiments are metric threads according to DIN 13. Instead of metric threads, trapezoidal threads, flat threads, saw threads, round or hygienic threads, pipe threads, Whitworth threads, UNF/UNC threads or the like can also be used. All screw bolts (60, 61) are manufactured, for example, of TiAL6V4 or TiAl6V4 ELI.

The base section (225) of the respective attachment carrier widens from the lower end face towards the attachment carrier plate (228). The attachment carrier post (233) located above the attachment carrier plate is substantially in the form of a straight cone tapering upwardly, thus away from the attachment carrier plate (228). The attachment carrier post (233) has a plurality of circumferential grooves in the lower third, which are interrupted by a laterally projecting anti-rotation lock bar (234). This creates an anti-rotation base for the superstructure (1, 2) to be carried.

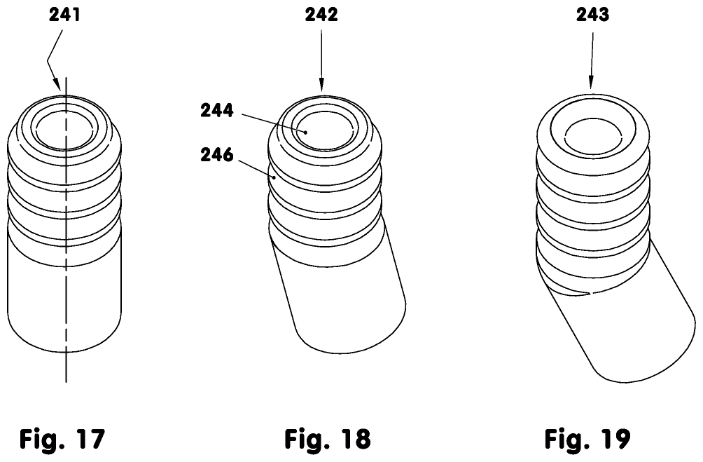

All attachment carriers (221-123) have a continuous multi-stepped recess (251), which has a conical seat (226) in the lower region, see FIG. 16. In the conical seat (226), for example, there are four bars (227) that fit positively into the notches of the anti-rotation lock (32, 238). The conical seat (226) opens into a short cylindrical recess for receiving the tightening region (180) of the attachment screw bolt (161), see FIG. 3. The cylindrical recess is adjoined by the internal drive thread (172), which is engaged by the external drive thread (171) of the attachment bolt (161). The diameter of the cylindrical recess is larger than the core diameter of the internal drive thread (172) of the attachment screw bolt (161). This creates a stop collar against which the stop flange (178) of the attachment screw bolt (161) comes into contact during pre-assembly.

The base section (225) of the attachment carrier (222) is angled eleven degrees with respect to the attachment carrier post (233). In the case of the attachment carrier (223), this angular deflection amounts to 22 angular degrees.

FIGS. 17 to 20 show the attachment carriers (241-243). All of these attachment carriers consist of a straight or cylindrical tube, which is smooth-walled in the lower region and has, for example, circumferential grooves (246) in the upper region. The tube has an external diameter of, for example, 3.24 mm. In the exemplary embodiment, the grooves have a radius of 0.45 mm. The pitch from groove to groove amounts to 1.1 mm. The smallest internal diameter of the tube amounts to 1.62 mm.

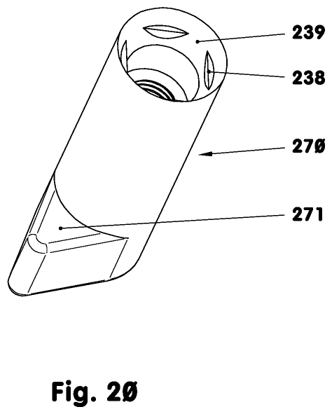

According to FIG. 18, the smooth-walled region of the attachment carrier (242) is angled by eleven degrees relative to the region equipped with grooves. In FIG. 19, the angular deflection amounts to 22 angular degrees. The geometrical shape of the second assembly joint of the attachment carriers (241-243) corresponds to the geometrical shape of the attachment carriers (221-223). The same applies to the scanning gauge (270) shown in FIG. 20. The latter has a radially projecting scanning tooth (271) on one side at its free end. The scannable, 2.5 mm thick scanning tooth (270) has two parallel end faces and two tooth flanks enclosing a 40° angle.

With the aid of any combination of straight or angled superstructure main carriers (20; 21a-21d) and straight or angled attachment carriers (221-223; 240-243), a variety of angular positions between the implant body and the position of the attachment carriers can be created, taking into account the fact that the carriers can also be positioned in a manner rotated relative to each other. The number of angular positions is also increased if, in one case or another, the anti-rotation lock between the single superstructure main carrier (20; 21a-21d) and the single attachment carrier (221-223; 240-243) is omitted.

LIST OF REFERENCE SIGNS:

| | |
|---|---|
| 1 | Denture, prosthetic, partial or total prosthesis, superstructure |
| 2 | Denture, prosthetic, bridge, superstructure |
| 3 | Jaw bone |
| 4 | Gum |
| 7 | Framework, reinforcement |
| 8 | Gum replica, elastic |
| 9 | Crown |
| 10 | Implant body |
| 12 | Implant shoulder |
| 13 | Recess, stepped |
| 14 | Internal cone, first zone, cone, cone seat |
| 15 | Internal hexagon, second zone, coupling geometry |
| 17 | Threaded bore, third zone for (82) |
| 20 | Superstructure main carrier to screw bolt (60) |
| 21a | Superstructure main carrier to screw bolt (61), straight |
| 21b | Superstructure main carrier to screw bolt (61), 22° angle |
| 21c | Superstructure main carrier to screw bolt (61), 30° angle |
| 21d | Superstructure main carrier to screw bolt (61), 45° angle |
| 23 | Implant post |
| 24 | Taper shape, hollow cone, taper post |
| 25 | Spherical shape, hollow sphere, spherical post |
| 27 | Internal thread for (160) |
| 28 | Cone seat, parts of a notch, anti-rotation lock |
| 29 | Center line |
| 31 | Implant plate |
| 32 | Plate segments, part of a notch |
| 33 | Rim |
| 36 | Center point, intersection |
| 37 | Rim upper side, flat |
| 41 | First assembly joint |
| 42 | Implant neck |
| 43 | Implant cone, external cone |
| 44 | Anti-rotation lock, external hexagon, coupling geometry |
| 51 | Recess, bent if applicable |
| 52 | First, lower zone, lower recess |
| 53 | Second zone, lower recess |
| 54 | Stop collar |
| 56 | Third zone, hemispherical surface |
| 57 | Fourth, upper zone; bore, cylindrical |
| 59 | Center line of (56, 57) |
| 60 | Screw bolt with stop flange, long |
| 61 | Screw bolt with opposing threads |
| 63 | Articulation region |
| 65 | Tool recess |
| 66 | Internal hexagon socket, internal hexagon |
| 70 | Drive region |
| 71 | External drive thread, external thread, drive thread, left-hand thread |
| 72 | Internal drive thread, internal thread, drive thread, left-hand thread |
| 73 | Drive pairing, drive thread, pairing |
| 75 | Intermediate region |
| 76 | Cylinder journal |
| 78 | Stop flange, stop collar |
| 79 | Notch |
| 80 | Tightening region |
| 81 | External tightening thread, external thread, tightening thread |
| 82 | Internal tightening thread, internal thread, tightening thread |
| 83 | Tightening pairing, tightening thread, pairing |
| 121 | Bore in (9) |
| 122 | Bore in (7) |
| 123 | Sealing plug for (9) and/or (240) |
| 124 | Filler material, unbonded; Teflon tape |
| 151 | Recess, bent if applicable |
| 160 | Attachment carrier screw with head, short |
| 161 | Attachment screw bolt with opposing threads; attachment carrier |
| | fastening means |
| 162 | Screw head seating surface, conical |
| 165 | Tool recess |
| 166 | Internal hexagon |
| 167 | Screw head, radially external cylindrical |
| 168 | External thread |
| 170 | Drive region |
| 171 | External drive thread, external thread, drive thread, left-hand thread |
| 172 | Internal drive thread, internal thread, drive thread, left-hand thread |
| 173 | Drive pairing, drive thread, pairing |
| 178 | Stop flange, stop collar |
| 180 | Tightening region |
| 181 | External tightening thread, external thread, tightening thread |
| 182 | Internal tightening thread, internal thread, tightening thread |
| 183 | Tightening pairing, tightening thread, pairing |
| 185 | External thread, right-hand thread |
| 221 | Attachment carrier with plate, straight |
| 222 | Attachment carrier with 11° angular deflection |
| 223 | Attachment carrier with 22° angular deflection |
| 225 | Base section |
| 226 | Cone seat |
| 227 | Bars |
| 228 | Attachment carrier plate |
| 233 | Attachment carrier post |
| 234 | Anti-rotation lock bar |
| 238 | Anti-rotation lock, external square, coupling geometry |
| 239 | Second assembly joint |
| 240 | Attachment carrier, short with grooves, straight |
| 241 | Attachment carrier, long with grooves, straight |
| 242 | Attachment carrier, long with 11° angular deflection |
| 243 | Attachment carrier, long with 22° angular deflection |
| 244 | Bore, central |
| 246 | Grooves |
| 251 | Recess, bent if applicable |
| 270 | Scanning gauge |
| 271 | Scanning tooth |

1.-13. (canceled)

14. A system, comprising:
a multi-part superstructure carrier (20, 21a-21d; 221-223; 240-243), which carries a superstructure (1, 2); and
an implant body (10), which has an internal tightening thread (82),
wherein a part of the multi-part superstructure carrier (20, 21a-21d; 221-223; 240-243) is arranged on the implant body (10) via an implant screw bolt (60, 61),
wherein the multi-part superstructure carrier (20, 21a-21d; 221-223; 240-243) comprises
a superstructure main carrier (20, 21a-21d) and
an attachment carrier (221-223; 240-243) that is detachably screwed to the superstructure main carrier,
wherein the superstructure main carrier (20, 21a-21d) has a recess (51) open towards the attachment carrier (221-223; 240-243) and towards the implant body (10),
wherein an internal drive thread (72) is arranged in the recess (51) in its region turned towards the implant body (10),
wherein the implant screw bolt (60, 61) has two external threads (71, 81) arranged one behind the other with or without a spacing,
a first of the two external threads (71, 81) being an external drive thread (71) and
a second of the two external threads (71, 81) being an external tightening thread (81),
wherein the two external threads (71, 81) have different slopes,
wherein the external drive thread (71) fits into the internal drive thread (72) of the recess (51) of the superstructure main carrier (20, 21a-21d) and the external tightening thread (81) fits into the internal tightening thread (82) of the implant body (10),
wherein the attachment carrier (221-223; 240-243) has a recess (151) open towards the superstructure (1, 2) and the superstructure main carrier (20, 21a-21d), and
wherein an internal thread (172) or a screw head seating surface (168) is arranged in the recess (151) in its region turned towards the superstructure main carrier (20, 21a-21d).

15. The system according to claim 14,
wherein the superstructure main carrier (20, 21a-21d) comprises
an implant post (23), and
an implant cone (43),
the implant post (23) being angled relative to the implant cone (43).

16. The system according to claim 15,
wherein the implant post (23) of the superstructure main carrier (20, 21a-21d) has a taper or cone shape (24, 25).

17. The system according to claim 14,
wherein the attachment carrier (221-223; 240-243) is either a straight hollow extension of the implant post (23) or forms an angled tubular component.

18. The system according to claim 14,
wherein the implant body (10) and the superstructure main carrier (20, 21a-21d) have, at least in regions, a complementary coupling geometry (44) for securing rotation resistance.

19. The system according to claim 14,
wherein the superstructure main carrier (20, 21a-21d) and the attachment carrier (221-223; 240-243) have, at least in regions, a complementary coupling geometry (238) for securing rotation resistance.

20. The system according to claim 14,
wherein the recess (51) of the superstructure main carrier (20, 21a-21d) and the recess (151) of the attachment carrier (221-223; 240-243) traverse between respective front and rear ends.

21. The system according to claim 14,
wherein the external drive thread (71, 171) and the internal drive thread (72, 172) form a drive pairing (73, 173) and the two tightening threads (81, 82, 181, 182) form a tightening pairing (83, 183),
wherein the threads of the drive pairing (73, 173) and the threads of the tightening pairing (83, 183) have different slopes with the same slope sign.

22. The system according to claim 21,
wherein the threads (71, 72; 171, 172) of the drive pairing (73, 173)—with the same slope sign of the threads (71, 72, 81, 82; 171, 172, 181, 182)—have a smaller slope than the threads (81, 82; 181, 182) of the tightening pairing (83, 183).

23. The system according to claim 21,
wherein the threads (71, 72, 81, 82; 171, 172, 181, 182) of both pairings (73, 83; 173, 183 have different slope signs.

24. The system according to claim 23,
wherein the threads (71, 72; 171, 172) of the drive pairing (73, 173) each have a negative slope sign, that is, they are counterclockwise-ascending threads (71, 72; 171, 172).

25. The system according to claim 24,
wherein the threads of the pairings (73, 83; 173, 183) have different thread diameters.

26. The system according to claim 14,
wherein the screw bolt (60, 61; 160, 161) has a stop collar (54, 78; 154, 178) between or—in the tightening screw-in direction—behind the external threads (71, 81; 171, 181).
